(19) United States
(12) Patent Application Publication
(10) Pub. No.: US 2007/0226763 A1
(43) Pub. Date: Sep. 27, 2007

(54) System And Method Of Provising User Specified Information And Advertising

(76) Inventors: James D. Hempleman, Chicago, IL (US); Sandra M. Hempleman, Chicago, IL (US)

Correspondence Address: WELSH & KATZ, LTD, 120 S RIVERSIDE PLAZA, 22ND FLOOR, CHICAGO, IL, 60606, US

(21) Appl. No.: 11/754,191

(22) Filed: May 25, 2007

Related U.S. Application Data
(62) Division of application No. 10/226,565, filed on Aug. 23, 2002, now abandoned.
(60) Provisional application No. 60/314,929, filed on Aug. 24, 2001.

(51) Int. Cl. G06F 13/00

(52) U.S. Cl. 725/46

(57) ABSTRACT

A user responsive process facilitates selecting types of information and/or advertisements that are of interest to a particular user. The selected types of information or advertisements can be interspersed with other types of works selected by the user or can be displayed while other software runs.

The benefit of an Aug. 24, 2001 filing date for Provisional Patent Application Ser. No. 60/314,929 is hereby claimed.

### FIELD OF THE INVENTION

The invention pertains to systems and methods for providing information or advertisements to an on-line user. More particularly, the invention pertains to such systems and methods wherein the categories of information or advertisements are user selectable.

### BACKGROUND OF THE INVENTION

Since the invention of radio, TV and other media, those companies wishing to advertise products and services have had significant difficulties reaching their desired audience. Advertisers must pay to broadcast ads to all listeners/viewers/etc. in order to reach the few who are actually interested in their products and services. At the same time, consumers are bombarded with advertising for products and services for which they have no use and/or interest.

Further, consumers are currently required to listen-view information services such as news, weather, sports, stock market, traffic, etc. at times predetermined by the radio/TV/etc. programming. There is currently no possibility of eliminating such information broadcasts, nor is there currently an ability to specify when they are to be provided.

Recent developments, as illustrated in, for example, U.S. Pat. No. 6,243,725, List Building System, issued Jun. 5, 2001, make it possible for individuals to program their own media playlists to replace the existing functions of radio, TV. and other media distribution businesses through use of a computer or other processor. These systems enable the user to select a playlist of songs (similar to radio), video (similar to TV programming, and other types of media, that will play sequentially and can, if desired, be repeated.

There continues to be a need for methods and systems which enable a user or recipient to specify and limit those types of third party media offerings which correspond to the user's interests. Such methods and systems potentially should attract media sources or advertising sources as the individuals which receive various presentations represent an interest group that have a greater or more positive response to the respective presentations than members of the general public.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a system block diagram;

FIG. 1A is an over-all flow diagram of a method in accordance with the invention;

FIGS. 2A, B taken together are a flow diagram of a set-up process for selected types of information;

FIG. 3 is a flow diagram of a process of presenting selected types of information to a user;

FIG. 4 is a flow diagram of a process of setting up selected types of ads in response to user input;

FIG. 5 is a flow diagram of a process of presenting selected types of ads to a user;

FIGS. 6A, B are exemplary screens to specify types of information to be broadcast;

FIG. 7 is an exemplary user profile screen;

FIGS. 8A, B, C, D are exemplary information services selection screens;

FIG. 9A is an exemplary screen for specifying keywords and cost constraints;

FIG. 9B is an exemplary screen for selecting specific broadcasts or excerpts to be presented;

FIGS. 10A, B are exemplary screens for creating indexes of information services broadcasts;

FIGS. 11A, B, C are exemplary ad classification screens;

FIGS. 12A, B, C are exemplary screens for user specification of ad classifications of interest;

FIG. 13 is an exemplary screen for user specification of cost classifications of interest;

FIG. 14 is an exemplary screen enabling a user to identify specific ads to be viewed;

FIG. 15 is an exemplary screen enabling a user to seek added information or to facilitate a purchase;

FIG. 16 is an exemplary screen illustrating presenting a business news alert while an e-mail is being composed;

FIG. 17 is presenting a news alert on a hand-held or wireless unit;

FIG. 18 is an exemplary screen presenting written media combined with an output from a weather service and an advertisement;

FIG. 19 is a software being executed with an excerpt being presented; and

FIG. 20 is a software being executed with an information services excerpt being presented.

### DETAILED DESCRIPTION OF THE PREFERRED EMBODIMENT

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

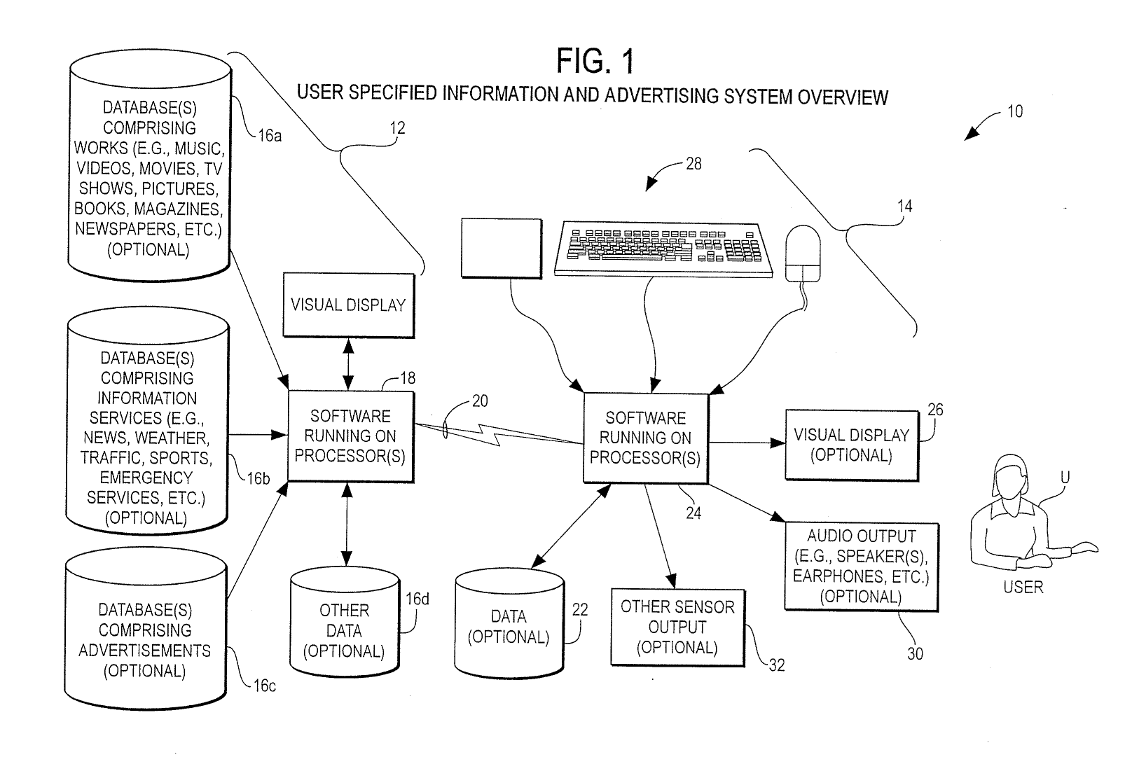

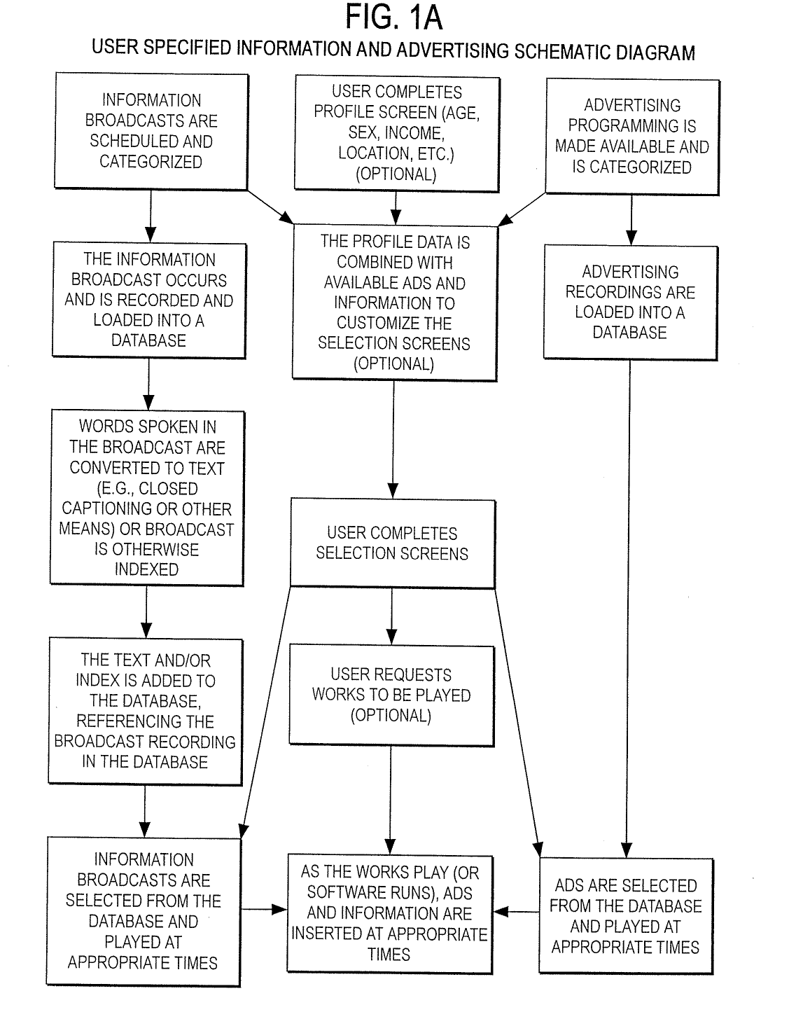

Systems and methods that embody the invention provide the ability for the user, i.e., the listener/viewer, to select the advertising and information services that are to be presented as well as the media that is presented. Using the present system and method, the user can select among various classifications of advertising and/or information services, which will be inserted as the playlist plays or as software runs, see FIG. 1A, Flow Diagram.

With the present system and method, the user might select among one or more classifications of information services (again, this might include news, weather, sports, stock market, traffic, etc.) and self-program the frequency and timing of such services. The user could determine what types of information services they desire and how often the services are provided as the playlists are played.

The user might specify the frequency of each service during various times of the day, week, month, etc. or they might omit certain services entirely. Many alternatives are possible for the options for selection of timing and frequency. Information offered on the selection screen could be dynamically modified based on the location, user's profile, times selected as well as other factors. Also, selected messages (for example, news on a specific stock) could be structured such that the information messages will periodically play until the user acknowledges that it has been heard/viewed. Charges might be imposed for various levels of the service.

In another aspect the user could select a specific information service and the most recent information will play. For example, selecting “Albania News” could offer the user options to play several the latest news broadcasts that include information on Albania. The user could be shown which items they have seen/heard and which they have not seen/heard.

Further, the service can offer the ability to listen/view information on specific topics immediately when information is available. Specific topics on news, sports, stocks, etc. can be selected for display on an “as it occurs” basis. For example, a sit-com program is temporarily interrupted for a news broadcast regarding Microsoft.

Also, the current “closed caption” technology that displays text on TV screens for various broadcasts or a similar process might be used to automate portions of the search for news items about specific topics. Similar to today's internet search engines, such a process could search for broadcasts for news, sports, etc., for specific topics. For example: this technology could be used to provide news on a relatively unknown company, sports team, person, town, etc.

Through a simple segmenting process (marking the start/end of each news topic during a broadcast) the end user could hear/view only the related part of the broadcast and could optionally avoid hearing/viewing the other parts of the broadcast. This could facilitate the indexing of broadcasts at a relatively low cost. In broadcasts where closed captioning is not available or will not be feasible, a simple key word index process can be structured to support the indexing and search of information services. The key words could be indexed to facilitate the display of information at appropriate times.

In addition to selecting information services, the user could direct the presentation of advertising. Giving the consumer the ability to select their own ads will help advertisers ensure that their message will reach receptive viewers/listeners who have an interest in their specific products and services. It will also eliminate the need for consumers to listen/view ads for products/services for which they have no use and/or interest.

Further, this process should reduce the cost of advertising. Advertisers will be able to pay for only the advertising that was actually delivered to consumers who actually have an interest.

The user's selection of ads might be based on specific types of product/services and might be further selected based on the level of expenditure as well as many other classifications.

Alternatives provided on the selection screens could optionally be dynamically generated based on the demographic profile of each user, the user's location, and the exact ads available.

In the ad selection process, users might only select ad categories, or they might specify a relative quantity of various ad classifications such as 50% sports-related, 25% beer, and 25% car advertising. Other selection criteria could be applied.

In addition, it is possible to maintain different profiles and selections for each listener/viewer in a home or other grouping. Ads and information services actually presented can be structured dynamically based on each specific listener/viewer based on computer login or by other methods.

This process will enable the user to listen/view ads to comparative shop for products for which they have specific interest. Taken to the next level, this can provide a new service: the ability to view/listen to ads on demand. In this mode of the invention the user could select the product/service and other characteristics and listen/view ads immediately. This can be thought of as the “Home Shopping Network”® with competition (i.e., the ability to view all competing ads for a particular product or service). It would also be valuable to provide direct links to product rating services such as “Consumer Reports”®.

In addition, the user can optionally be provided a “reject” feature that can offer the ability to discontinue certain ads. For example, the service might provide the ability to click/select a currently playing ad and provide the option to choose one or more of the following:
1. Immediately stop the specific ad playing;
2. Never allow that specific ad to be played again;
3. Never allow that specific product or service to be advertised again;
4. Never allow that company to advertise again;
5. Never advertise that class of product or service again.
6. Etc.

This can be used to eliminate unwanted or offensive ads and can also be used to limit selection while shopping for a specific product or service.

At the same time a “select” feature can optionally be implemented. While listening/viewing an ad, a user can “select” the product or service thus taking the next step in the sales process. The user might be provided options to request more information (i.e., the next ad), or request information to be sent, or request someone to call, or actually purchase the product/service immediately, or take additional steps in the sales process.

During the time when a user is involved in the sales process, the user might have an option to place the playlist on hold (which might be a logical choice if the current item is a sitcom or a movie), or to continue playing the playlist (which might be a logical choice if the current item is a song).

With the present system and method, advertisers can build series of ads and rotate them in sequence to deliver a more effective and complete message. The process can absolutely ensure that a series of ads are presented in a specific order, which cannot be done with media today, since users can turn off broadcasts or change channels at any time. In another aspect, the service can “remember” what ads have been presented and present the next sequential ad at the next appropriate time, even if the service has been turned off for many days. Further, logic can be provided to ensure that ads are repeated (or not repeated) at regular intervals based on the advertiser's desires. For example, if the service has not been used for five days, begin again with the first ad in a series of four ads.

Statistics can be a valuable by-product of the process. The actual number of listeners/views can be instantly known, thus providing billing statistics for advertising and information services as well as popularity statistics over a specific time such as weekly, monthly, annually, etc. Industry awards could be provided based on these statistics. Also, over time, these statistics can lead to more effective targeted direct marketing, making the mailing list potential very valuable.

In addition, the knowledge database from historical ad selection and product purchases can be used to poll consumers on the effectiveness of ads and products/services, to further improve advertising and product/service creation and delivery. (i.e., advertisers will know who viewed what ads.)

The actual amount and type of advertising and information services provided to each specific user might be a function of the level of service selected and paid by the user. For example: a user wishing to obtain the service for free might be required to listen/view a significant number of ads per hour (similar to today's radio and TV broadcasts). A user wishing to listen/view less advertising might pay a moderate fee per year/month/week/day/hour/etc. A user wishing to listen view no advertising (or only limited types of advertising) might pay a larger fee.

Likewise, a user desiring only basic information services might receive the services at no charge. A user desiring more complete or specialized information services may be required to pay an increased fee. Various levels of service could be structured to fit each user's needs, etc.

In addition, a version of advertising on demand that is essentially only advertising, with inclusion of some information services such as weather, news, sports, stocks, traffic broadcasts, etc. can be provided. This version would be especially valuable in public areas such as airports, train stations, shopping malls, etc. In this version the airport, mall, etc. might be compensated based on the type and frequency of ads played.

The present system and method are not limited to radio/TV replacement. The invention has applicability for all media delivery such as still picture slide shows, art delivery, newspaper/magazine/book distribution, etc. For example, if a person is reading a book (on a computer screen), an ad is displayed on the screen, and a verbal news broadcast alerts that person to immediate information on a specific stock. Another example might involve a still picture slide show. A person is viewing pictures and the process temporarily interrupts to provide news of the person's favorite sports team. There are many possibilities.

In another aspect, advertising and/or information services may be presented on a user station or presentation device while a software product is running. For example, the fee for using one or more specific software products might be waived or even eliminated if a specified amount of advertising is presented while the user is using the software. Suppose that a user wishes to use a specific game software. To obtain the right to use the software the user agrees to allow ads to be presented on their computer as the game software operates. Similar to the process of specifying advertisement classifications above, the user might direct the advertising to the most palatable alternatives. The end result is identical to the process when advertising is presented along with works. The advertisers reach a more receptive audience, and the user does not need to be bothered by advertising that has no relevance to their interests.

Similarly, infonnation such as news weather, traffic, sports, financial and emergency broadcasts may be presented while one or more other software products are operating, or even while a computer is running essentially nothing, waiting for the next task. For example, a user might be typing an e-mail message and an announcement regarding a stock that they are following is displayed. Or a user is playing golf and a selected news announcement is presented on a wireless device. There are many ways in which portions of the system and method might be applied.

FIG. 1 is a diagram of a system 10 which embodies the present invention. The system 10 can provide information and advertisements to a third party recipient in response to pre-established user profiles as well as pre-selected categories.

Remote sources 12 can be coupled to one or more user stations, presentation devices or user devices such as players or held-held units 14, either by a wired or wireless links 20 to provide information and/or advertisements to a third party recipient or user U. The sources 12 include a plurality of pre-established databases.

Database 16a includes various types of exemplary works such as music, video, movies, TV shows, still pictures, books and magazines, newspapers, as well as any other types of works, all without limitation which might be of interest to third party recipients or users. Another database 16b incorporates information from services such as news, weather, financial, politics, traffic, sports, emergency service information and the like, all without limitation. A third database 16c incorporates advertisements. The exact configuration of databases 16a, b, c is not a limitation of the invention.

Information stored in the databases 16a, b, c can be extracted by one or more processors executing software 18 and downloaded by the link 20 to presentation device or user station 14. Additional data and software executable on processors 18 can be stored in storage unit 16d.

The user station and presentation device 14 incorporates software running on one or more processors 24 which in turn are coupled to data storage unit 22. Storage unit 22 may store additional executable software and can also provide storage for works, information or advertisements downloaded from databases 16a, b and c as well as other data.

Other input/output devices may be optionally selected and coupled to the software and processors 24. These include one or more visual displays 26, user input devices 28 including keyboards, mouse, touch screen, keypads, buttons or the like, audio output devices such as speakers, ear phones 30 and any other types of sensory output devices 32 that might be appropriate for a particular type of user station or presentation device. It will be understood that neither the particular combination of input/output devices nor their configuration are limitations of the present invention.

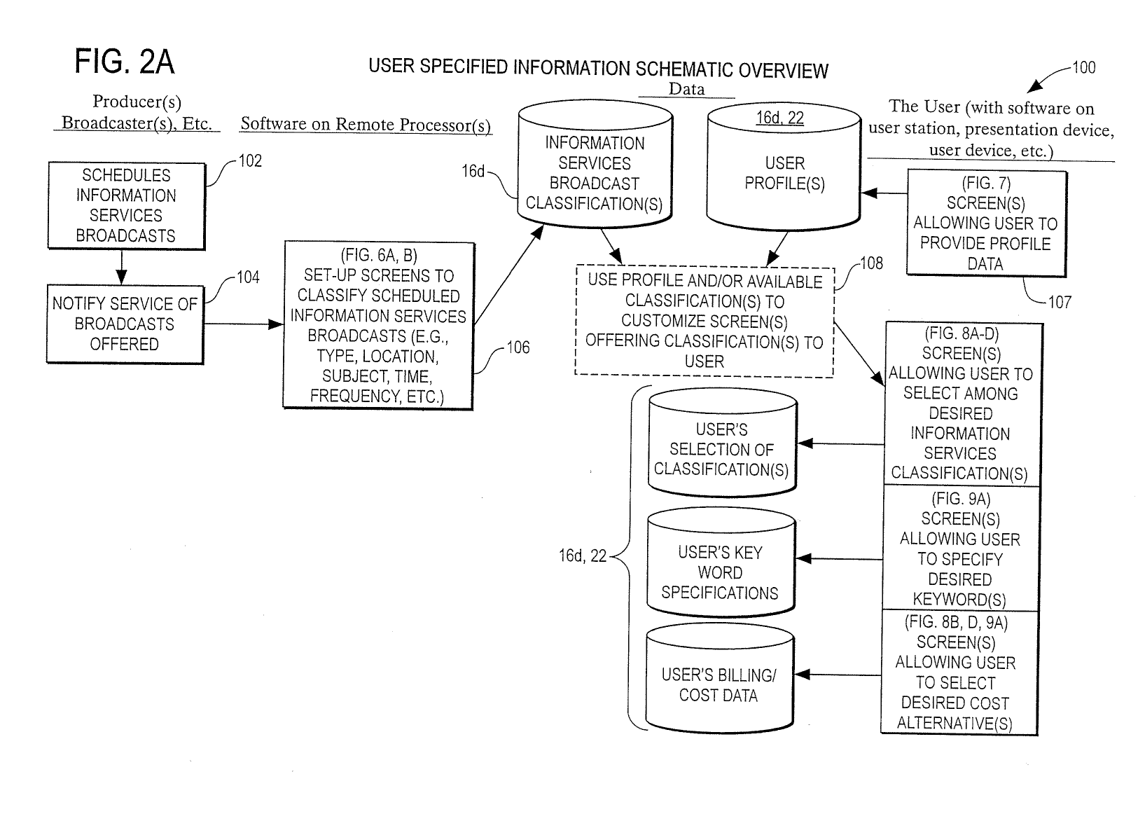

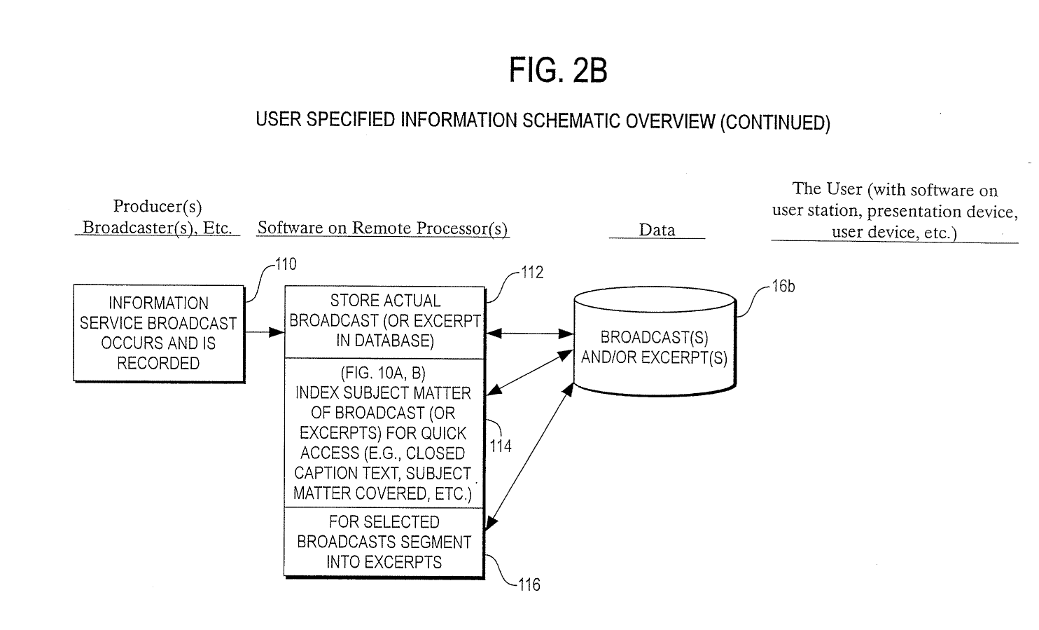

FIGS. 2A and B taken together illustrate a set-up process 100 of establishing the types of information present in the database 16b. In an initial step 102, various information services' broadcasts are scheduled. The infonnation providing services are notified as to the broadcasts which are expected to be available in a step 104.

In a step 106, the available types of information are classified as to type, location, subject, time, frequency, and so on using screens, such as exemplary screens 6A,B. The classified information is then stored storage unit 16d.

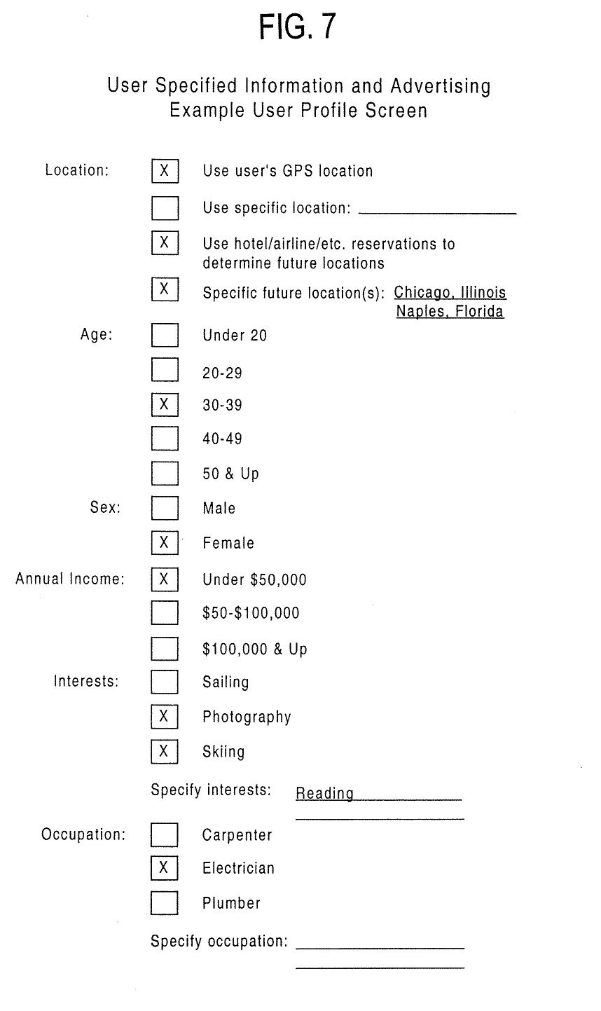

In a step 107 user U completes one or more profile defining screens, for example see FIG. 7. These screens facilitate the development of additional screens to be subsequently presented to the user pertaining to classifications of information services, keywords and desired cost alternatives. Information extracted from these screens can be stored in one or both of storage units 16d, 22.

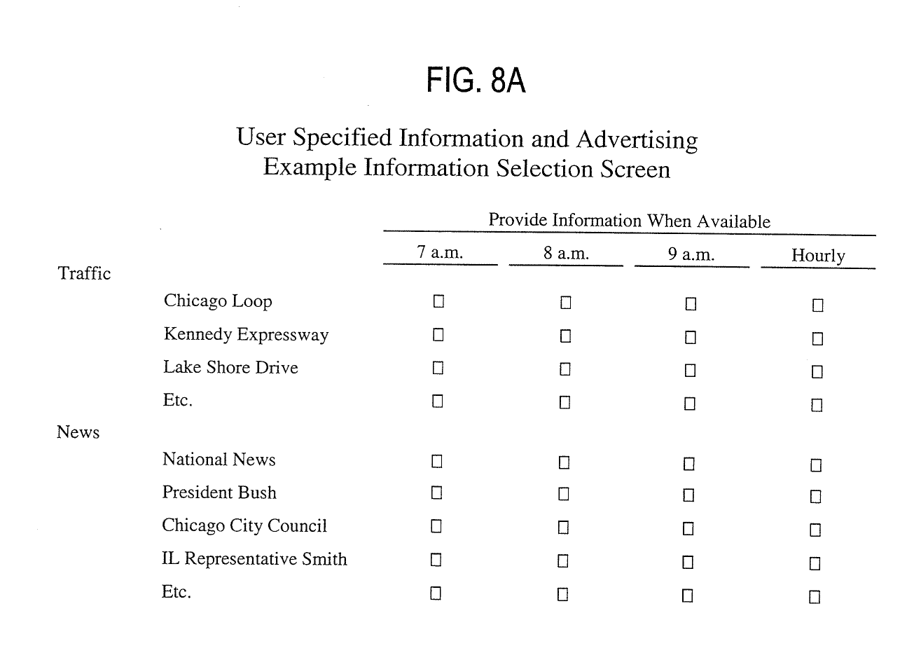

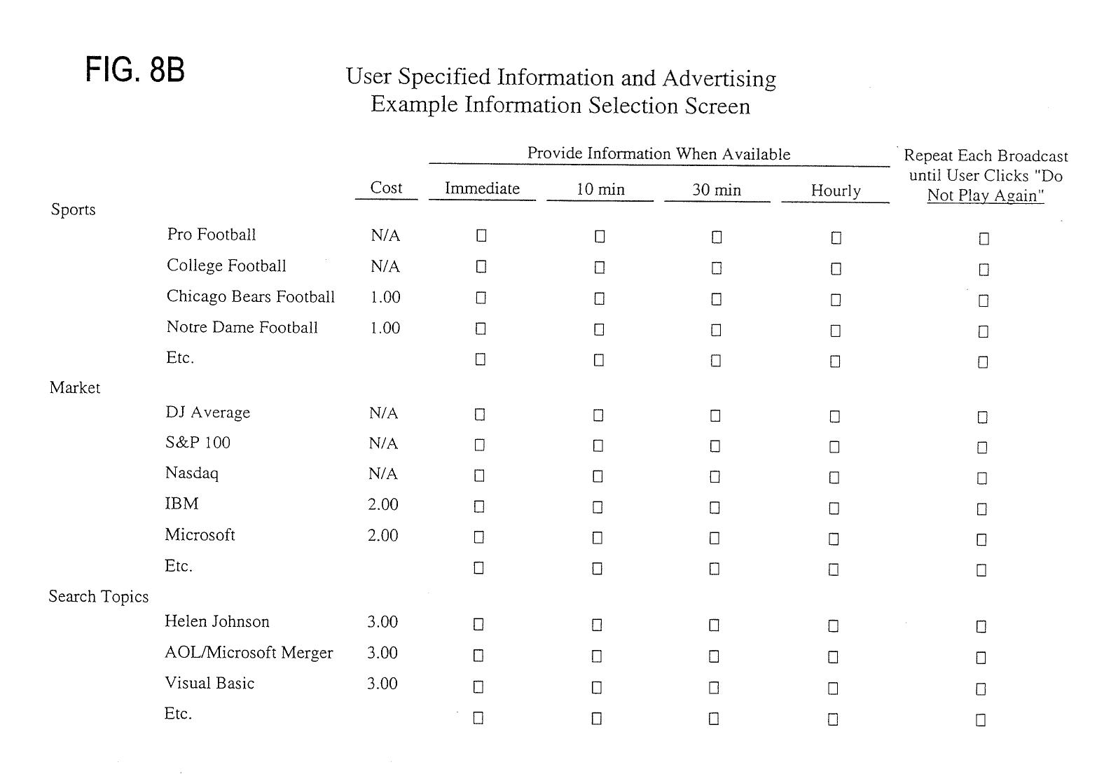

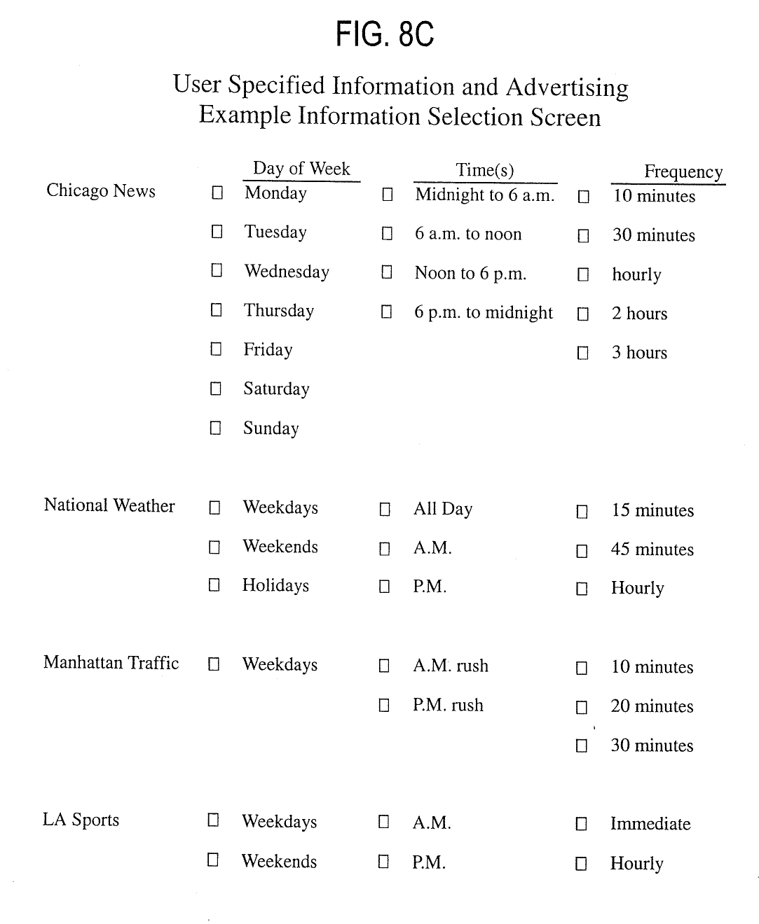

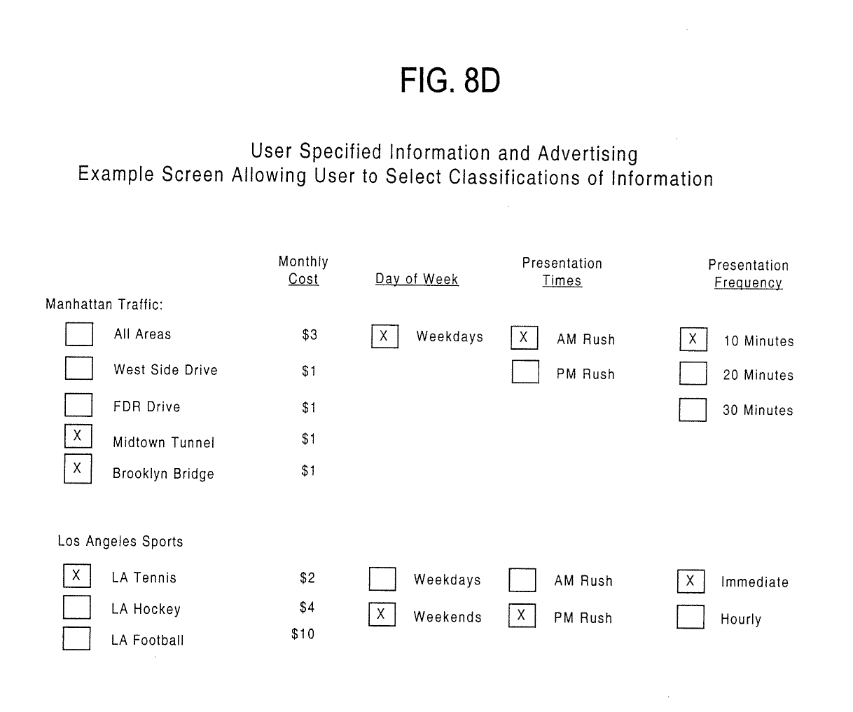

In a step 108, user profile information established in step 107, from either storage unit 16d or 22 is combined with classification information from storage unit 16d for presentation to the user U for selection purposes. One or more screens are presented to the user U enabling the user to select among the available classifications of infonnation services, see for example exemplary screens of FIGS. 8A, B, C, D. The user's selection of classifications can be stored in one or both of storage units 16d, 22.

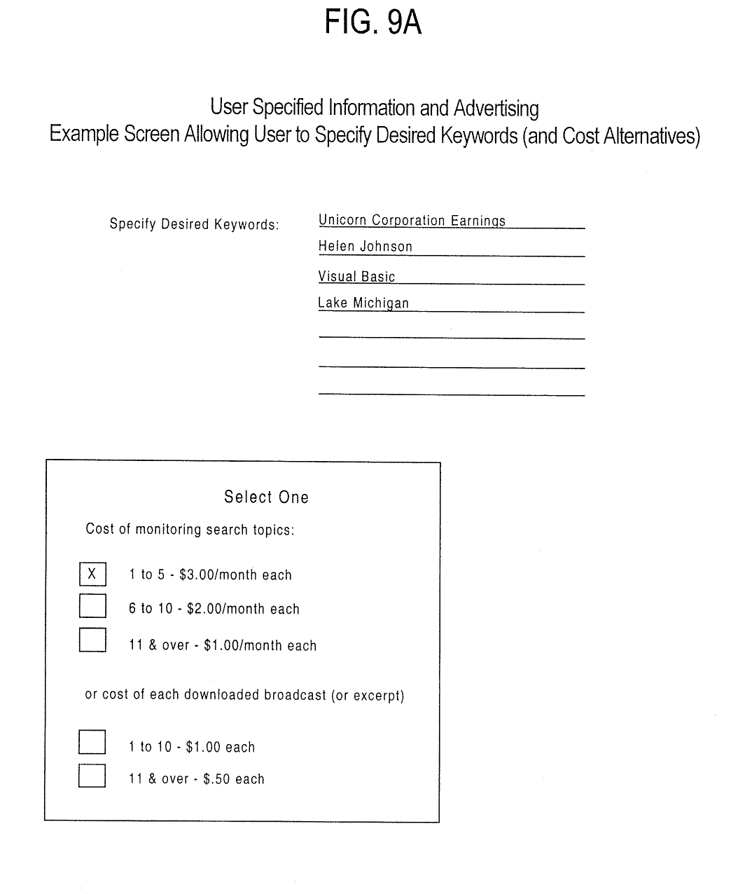

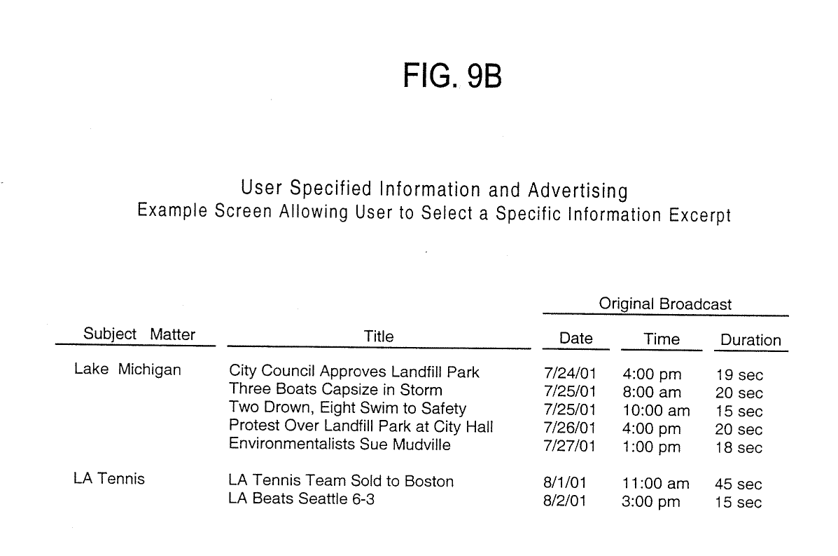

Screens can also displayed, see exemplary displays of FIGS. 9A enabling the user to specify desired keywords. The keywords in turn are also stored in the respective storage units. Screens can be also be displayed, see exemplary screens of FIGS. 9A, 8B, 8D enabling the user to select desired cost alternatives. Billing information is also stored in the respective storage devices.

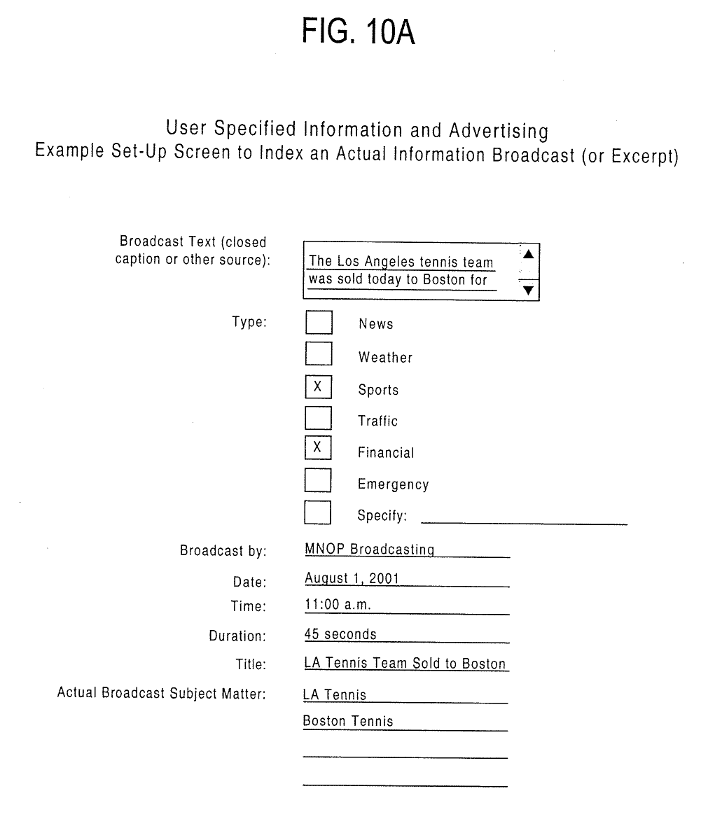

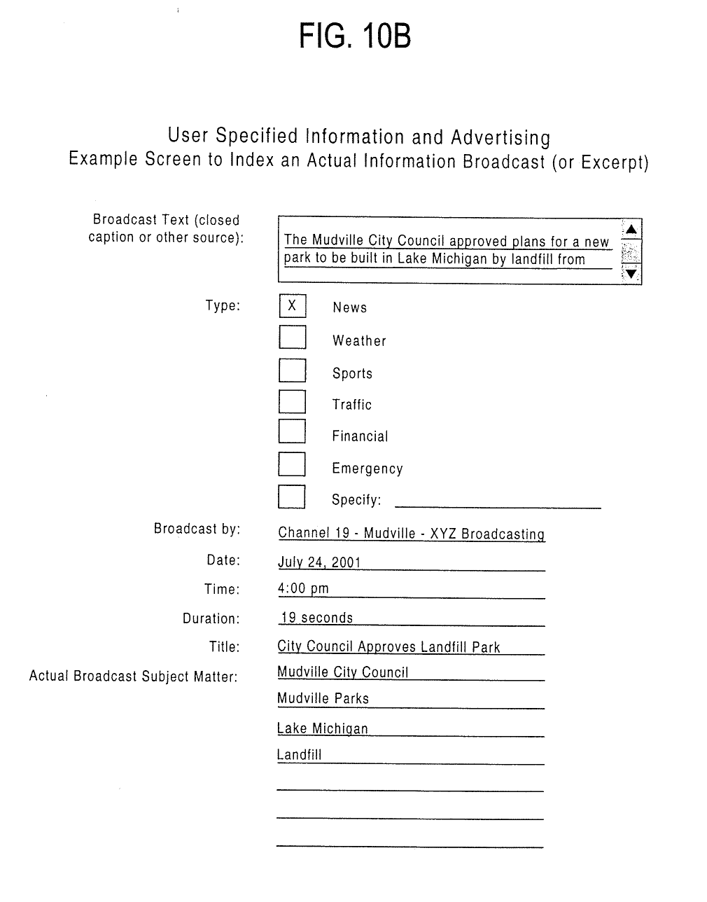

With respect to FIG. 2B, in step 110 the information service's or services' broadcasts occur. The information which is broadcast is recorded and stored in step 112 either in its entirely or as summaries and/or excerpts in database 16b. Indexes of the subject matter of the broadcasts or the excerpts can also be created using exemplary screens as in FIGS. 10A, B, and stored, step 114, in database 16b. Also, selected broadcasts can be segmented into excerpts and stored in database 16b, step 116.

As a result of executing the process 100, the various user selected categories of information have now been stored in the respective database 16b and are available to be downloaded via link 20 to one or more user station or presentation devices. In summary, the selection of stored information, has been based on the information received concerning user profile data, as well as user selections of desired information such as types of services, keywords or the like, all within the user's cost specifications or constraints.

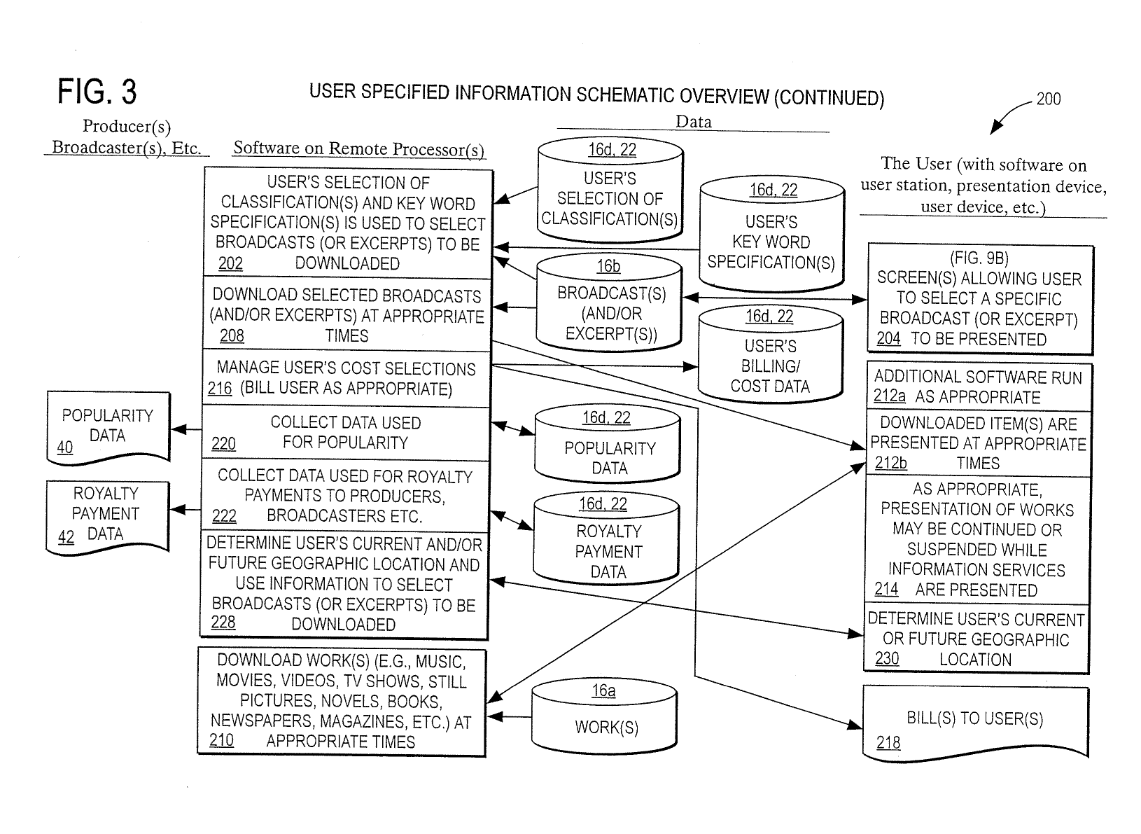

FIG. 3, a flow diagram of a method 200, illustrates presentation of selected information interleaved among and within downloaded works or while other software runs. In step 202, the user's selection of information classifications, keyword specifications, and the like is used to select broadcasts and/or excerpts to be downloaded based on previously collected information stored in units 16d and/or 22. In a step 204, screens can be presented, see FIG. 9B, which allows a user to select a specific broadcast or excerpt to be presented.

In a step 208, selected broadcasts and/or excerpts based on classification data, keyword specification data, and/or user selection of specific broadcasts or excerpts are downloaded at appropriate times along with works which may also be downloaded in a step 210 to the user station or presentation device 14. In step 212a, additional software can be executed in part at the user station or elsewhere as desirable or appropriate. In step 212b, the downloaded works and selected broadcasts and/or excerpts thereof are presented, consistent with software being executed and/or works being presented, if any, in step 212a, at appropriate times to the user U.

In a step 214, as appropriate, the presentation of works from the storage unit or database 16a, may be continued or suspended while the information, such as broadcasts and/or excerpts thereof, is presented. Concurrently, in step 220, data can be collected for providing popularity information for many uses such as creating a marketable output product 40. Additionally, in step 222, data can be collected for use in determining and/or making royalty payments to producers, artists, broadcasters and the like and for generating the royalty payment data 42.

In a step 228, additional services can be provided to the user U based on the user's current and/or future geographical location. Information can be obtained from a GPS-type system which tracks the user or from databases such as airline, hotel reservations or restaurant reservations made by the user. This information, which might also be obtained in step 230 from the user station or presentation device, or directly from the user can be used to select additional broadcasts or excerpts directed to the user's interests and/or needs to be downloaded and presented. Other ways to obtain such information come within the scope of the invention.

The user's costs can be managed, step 216, based on previously provided cost information and constraints. Invoices 218 can be generated to the user pursuant to the user's previously specified billing and cost data from one or both storage units 16d, 22.

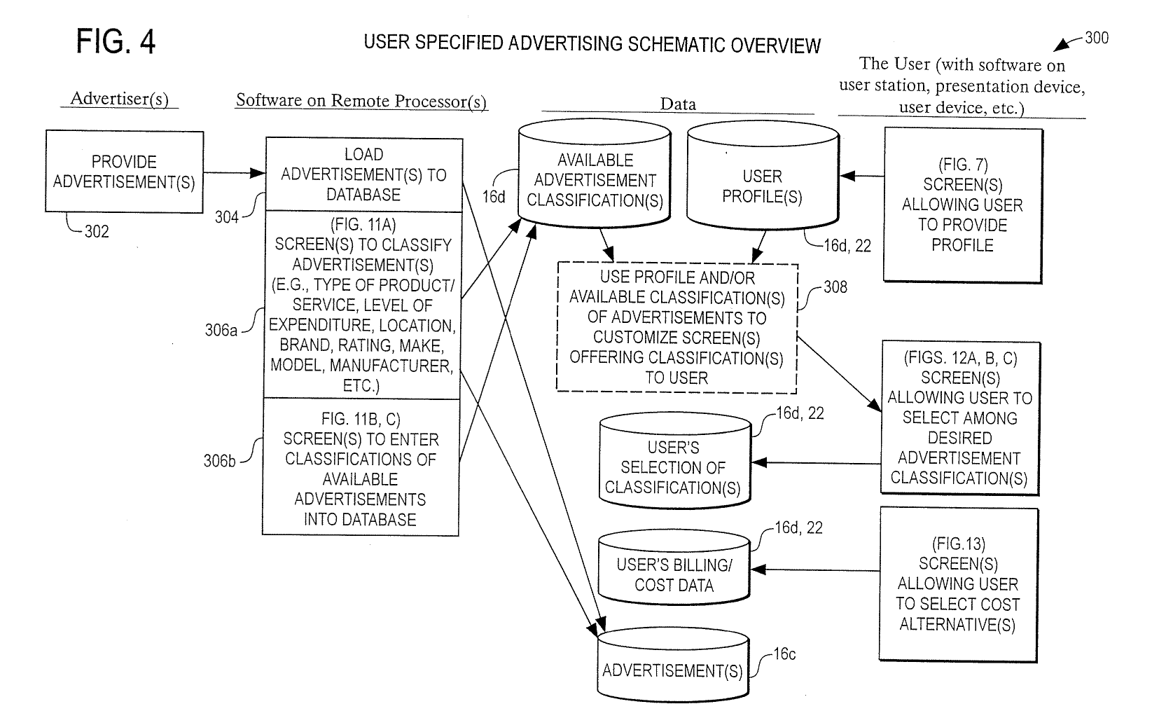

FIG. 4 is a flow diagram of a set up process 300 for establishing classifications or specific advertisements of interest which are to be presented to user U. In a step 302, advertisements are provided from a source such as an advertising agency or the like. The advertisements are loaded into the database 16c in a step 304.

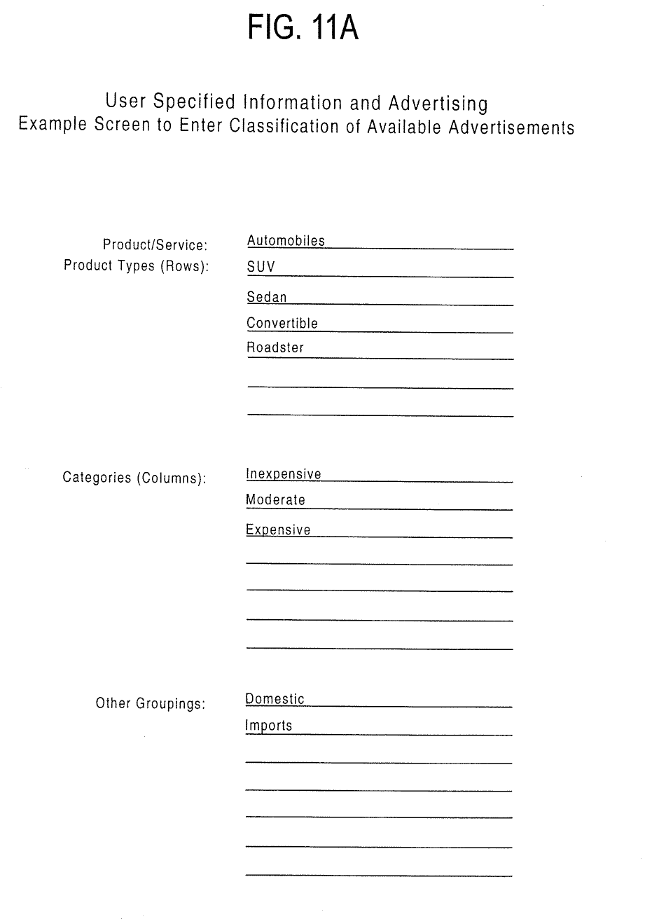

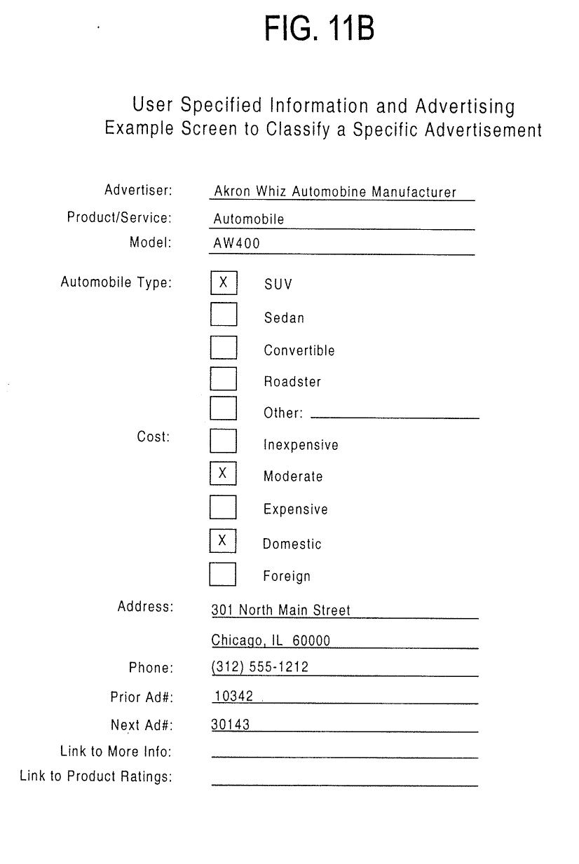

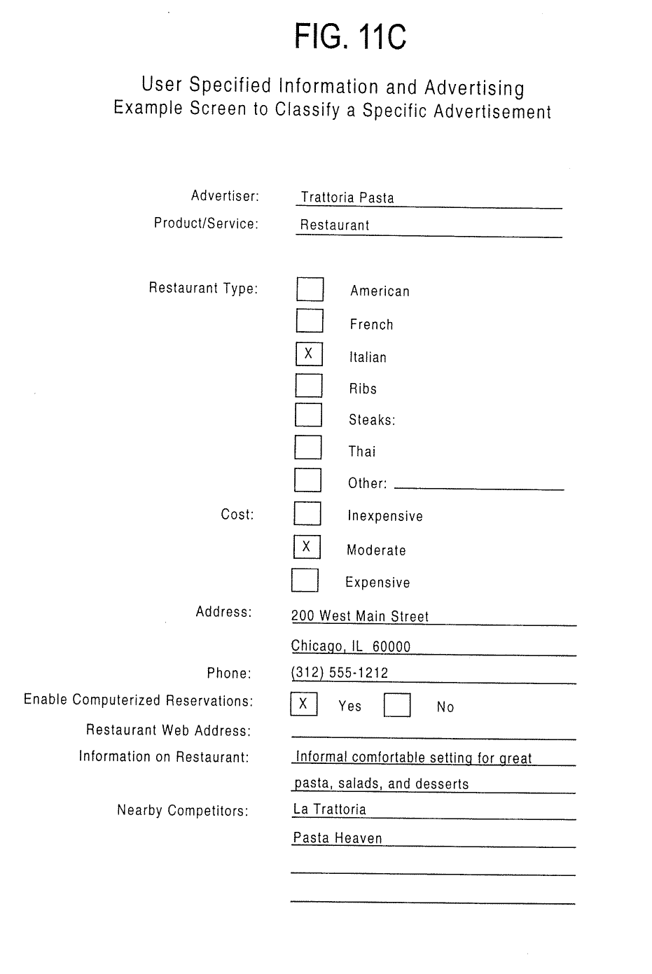

In a step 306a, screens can be presented, such as the exemplary screen of FIG. 11A to classify the advertisements into a plurality of classifications. In step 306b, other screens, such as the exemplary screens of FIGS. 11B, C, can be presented to enter the classifications of available advertisements into the database 16d.

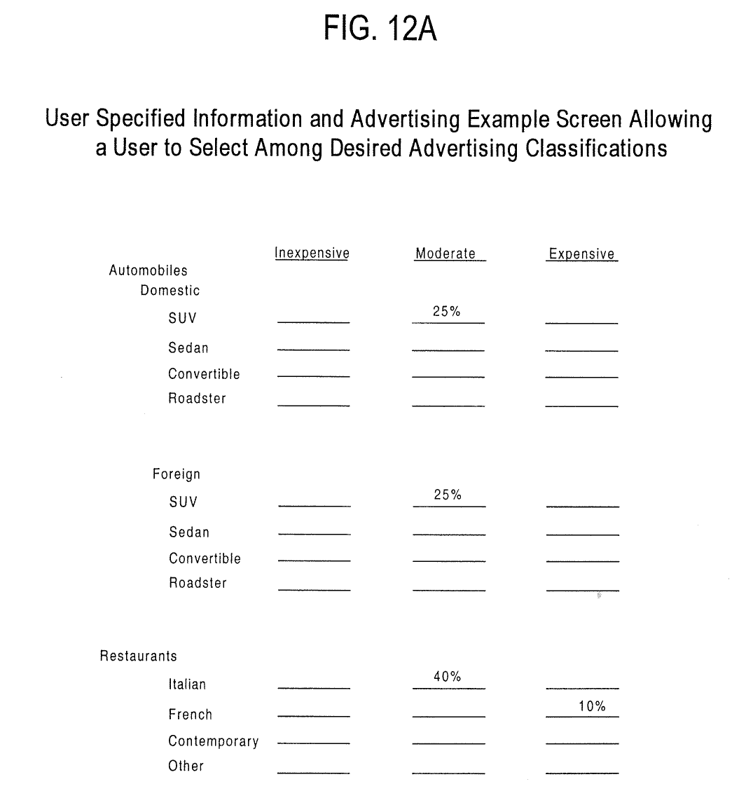

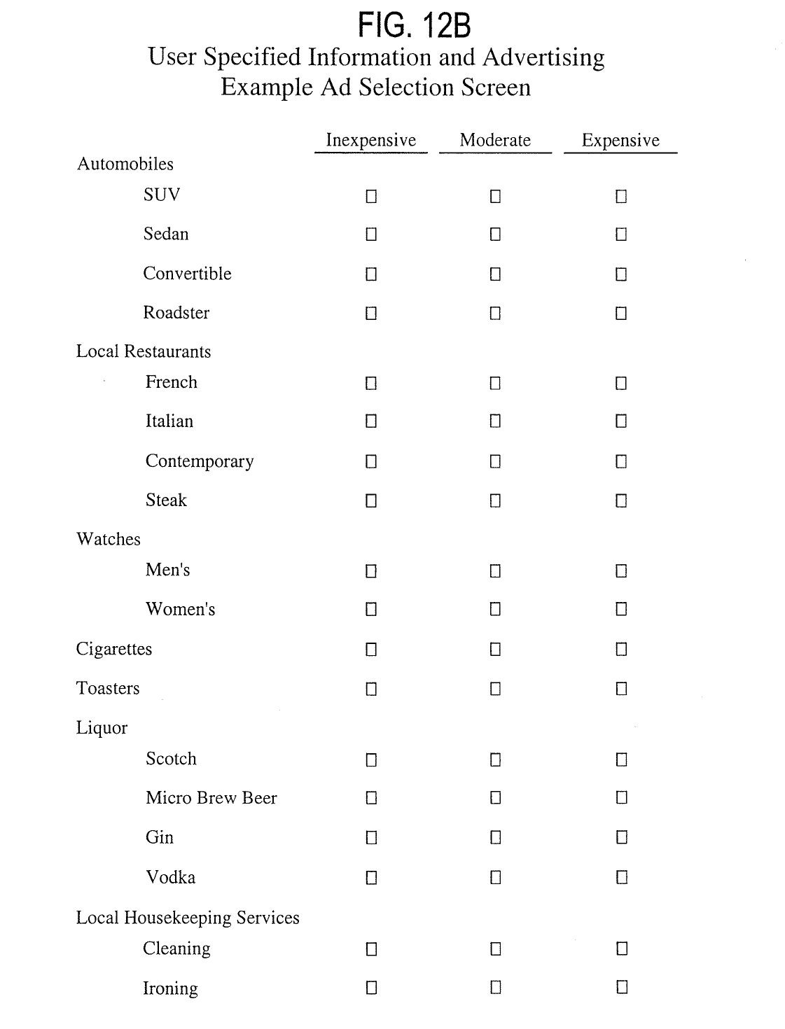

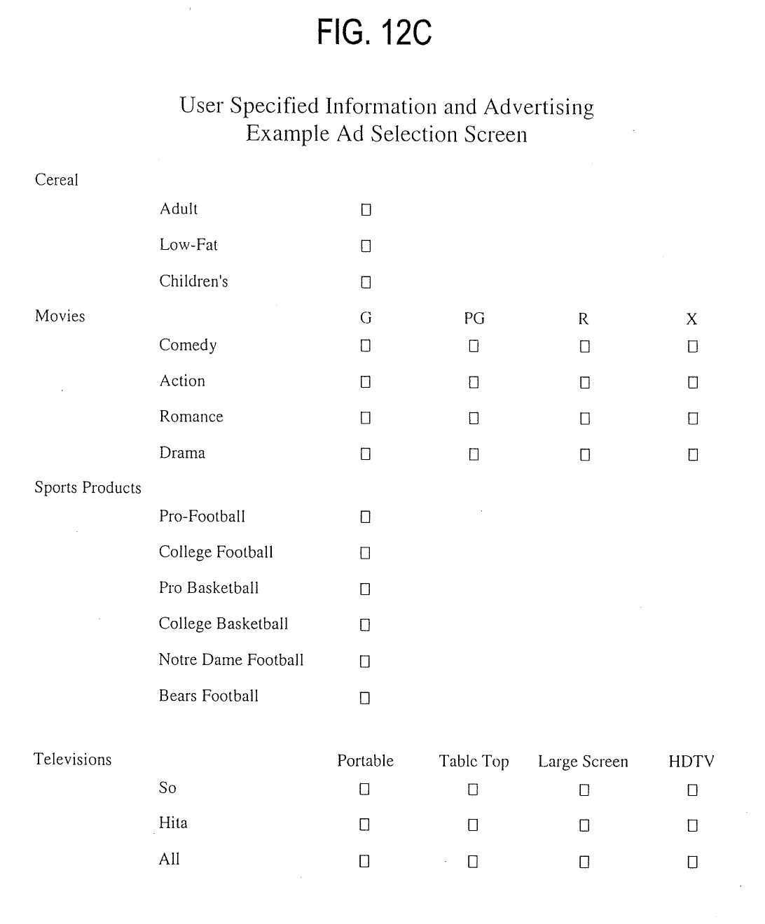

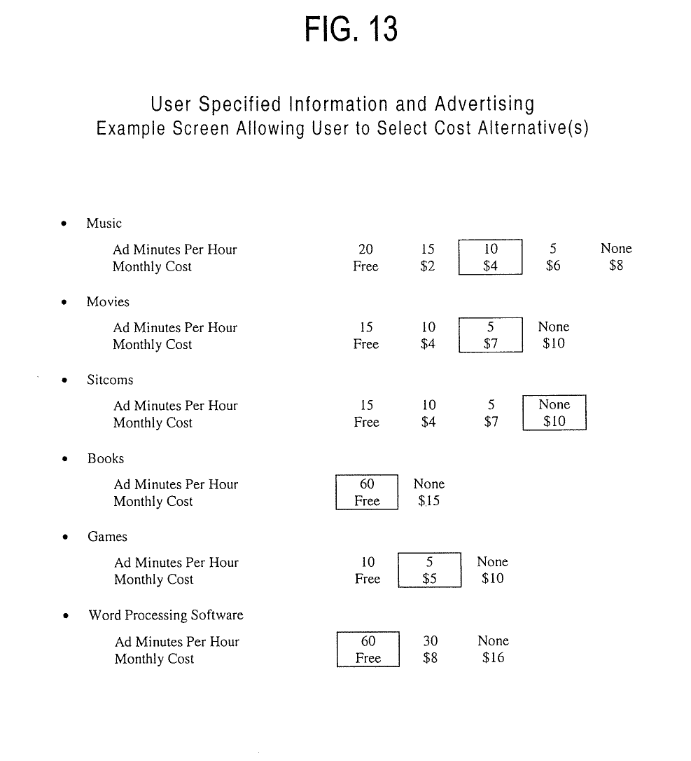

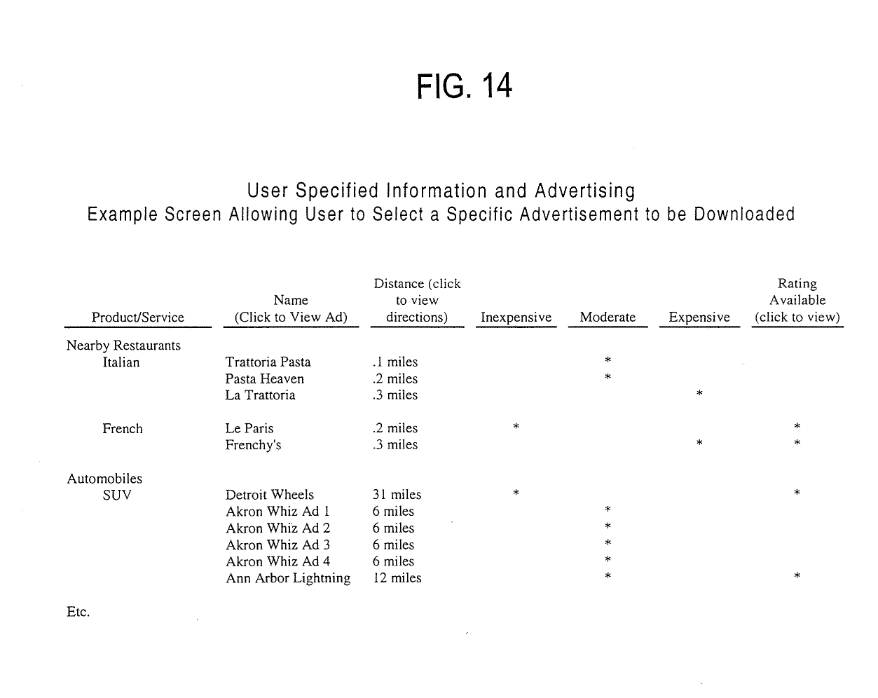

In a step 308, the available advertisement classifications and user profile, see screen of FIG. 7, information can be extracted and used to provide customized screens, based on user-specific information and available ad-classifications which the user can review to select the desired classifications, such as exemplary screens FIGS. 12A, B, C. The user's selected classifications can be stored in storage unit 16d or 22 or both. Additional screens, such as exemplary screen FIG. 13 can be presented to the user to enable the user to select and establish various costs alternatives relative to presented advertisements. This information is subsequently stored in database 16d or 22 or both.

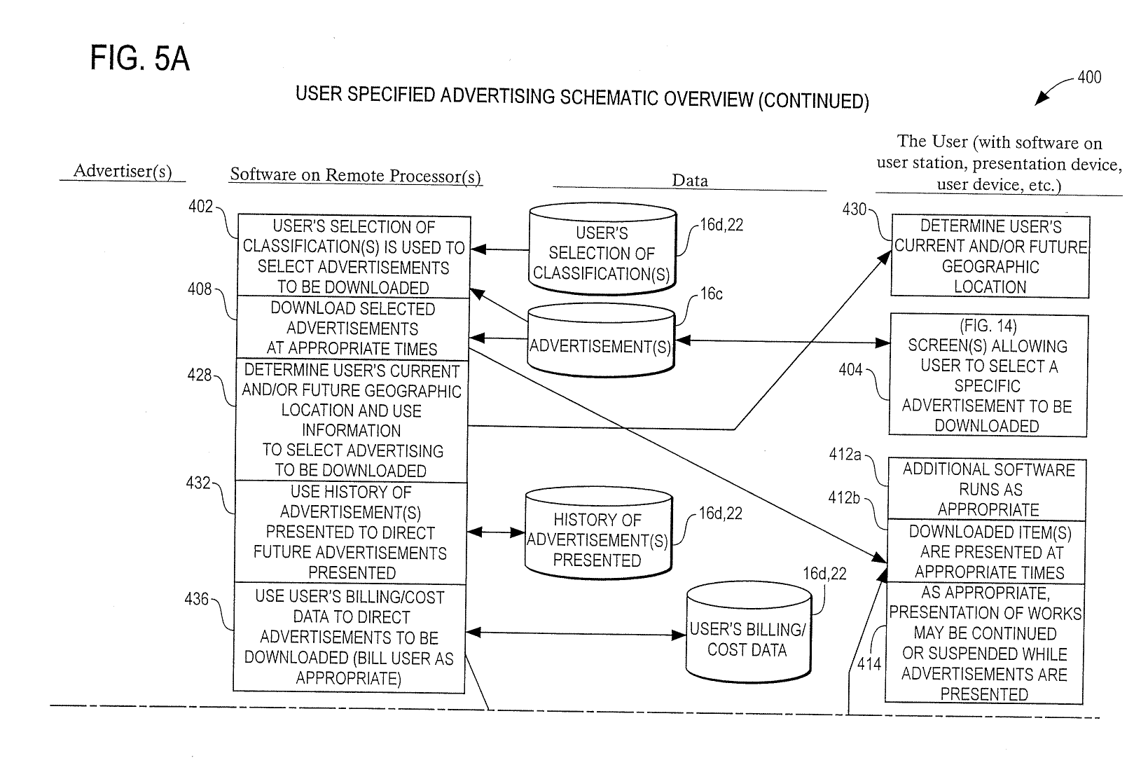

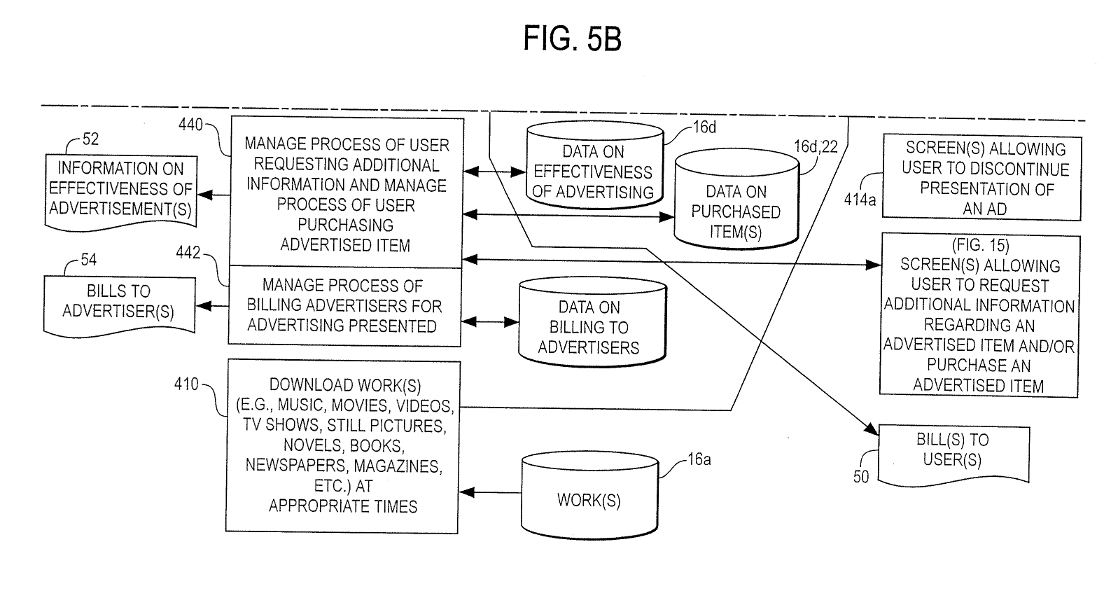

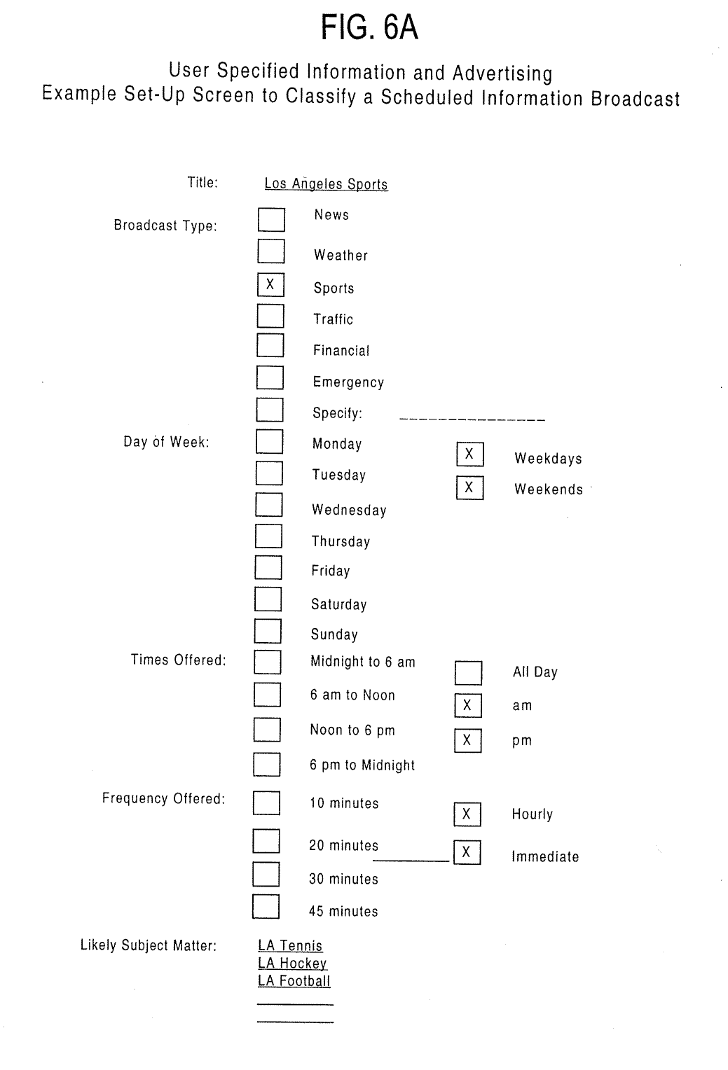

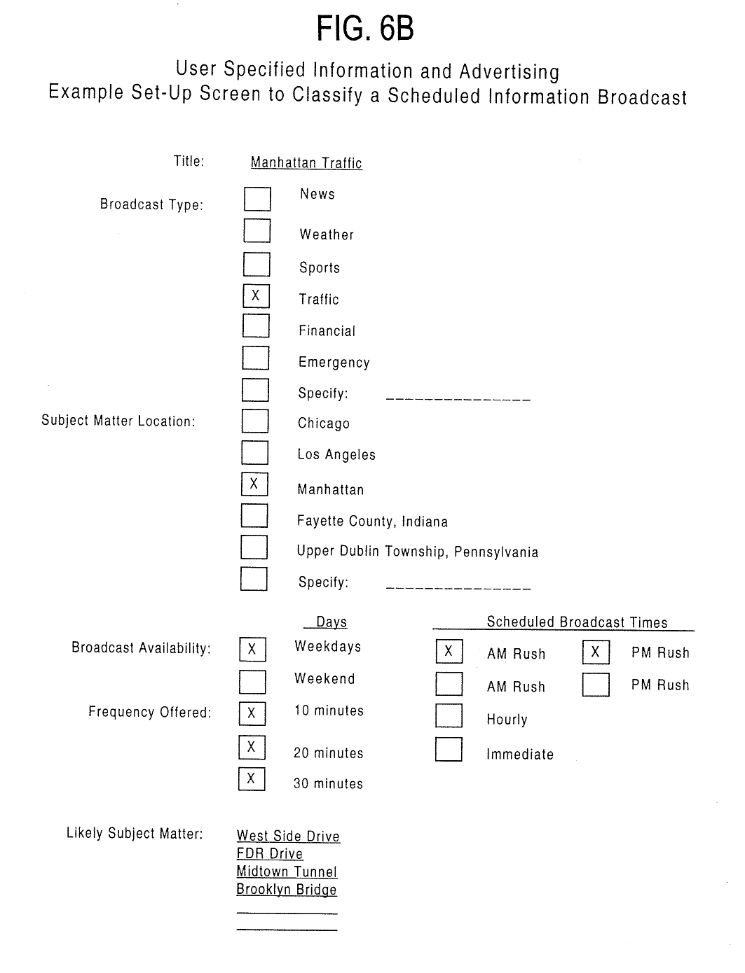

FIG. 5 illustrates a flow diagram of a process 400 for presenting advertisements in accordance with the user's previously established selections interleaved among and with various works being downloaded for the user's entertainment. In a step 402, the user's selection of classifications can be used to select advertisements from the database 16c to be downloaded. In a step 408, the selected advertisements are downloaded at appropriate times while works are being downloaded to the user in a step 410 and/or software is running in step 412a.

Additional software can also be executed, at least in part at the user station 14 or elsewhere as appropriate or desirable. The downloaded advertisements and works are presented at appropriate times step 412b. As necessary or appropriate, the presentation of works from the database 16a can be discontinued or suspended and then continued again while advertisements are presented to the user in a step 414. A screw can also be provided to terminate presentation of an ad, 414a.

In a step 428, the user's current and/or future geographical location can be determined, as discussed above, steps 228, 230 above or in combination with information received from the user U in a step 430. This infonnation can be used to select other advertisements to be downloaded to the user U at appropriate times. Other ways to obtain such information come within the scope of the invention.

In a step 432, a history of presented advertisements can be created for many purposes such as to provide information to direct which advertisements are to be presented in the future. History information can be stored in database 16d or 22 or both.

In a step 436, the user's billing and cost data can be used to generate invoices or bills 50 to the user based on the presented advertisements. In a step 440, information pertaining to the effectiveness of the presented advertisements can be stored in database 16d. In addition, the processing of user requested additional information can be managed as well as the process of facilitating user purchases of advertised items.

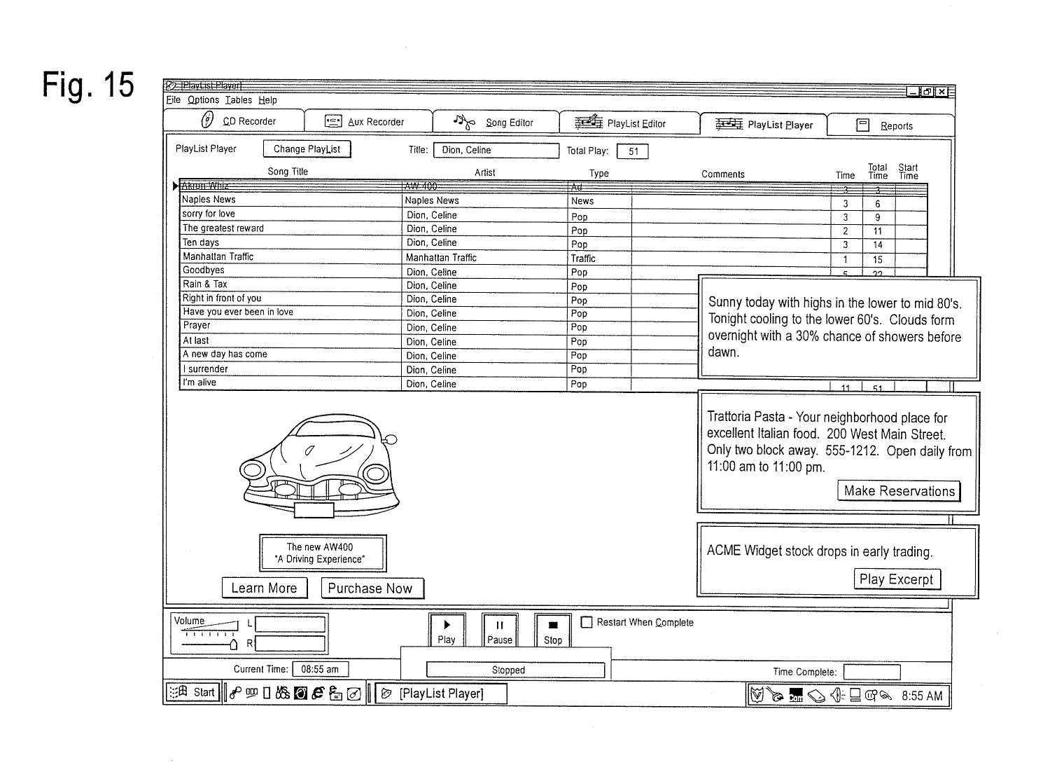

As part of the process of managing the user's requesting additional information or purchasing advertised items, step 440, additional screens, such as exemplary screens FIG. 15, can be displayed enabling the user to request additional information regarding an advertised item or for purposes of facilitating purchase of an advertised item.

Information pertaining to effectiveness of advertisements can be processed and created as a marketable product 52 to advertisers and others. In a step 442, advertisers can be invoiced or billed 54 for presented advertising.

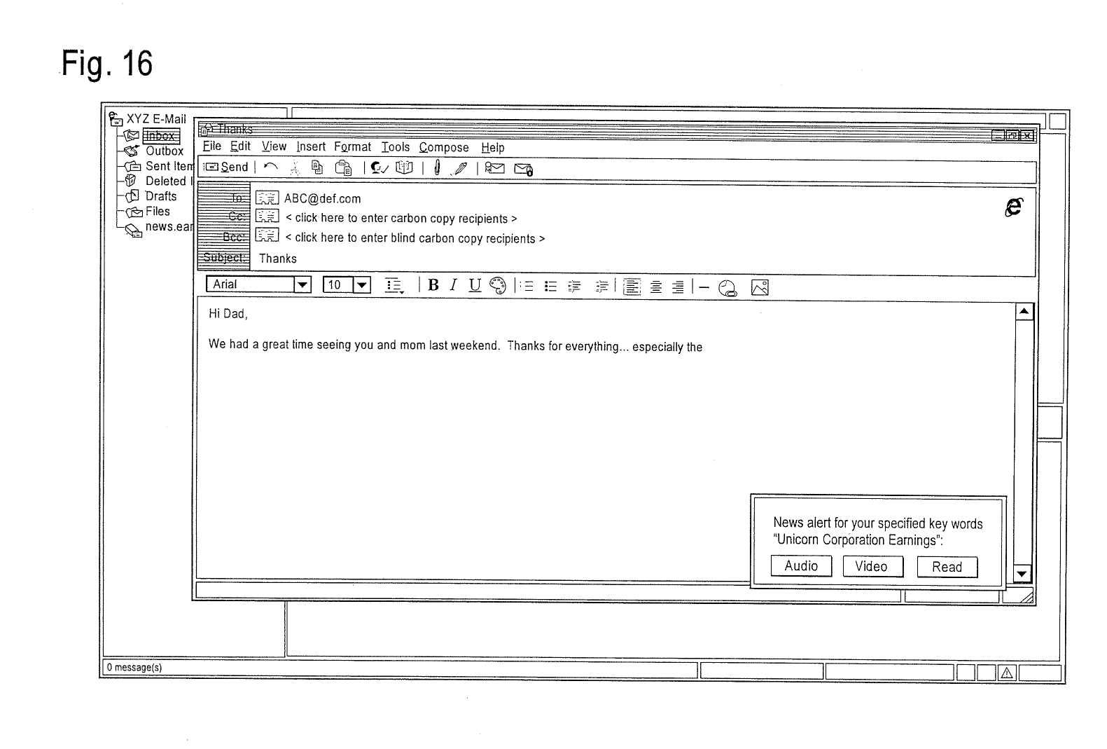

FIGS. 16-20 are screens illustrative of aspects of the present process. In FIG. 16, a business news alert has been presented while an e-mail was being composed. (An example of executing additional software as in steps 212a, 412a.)

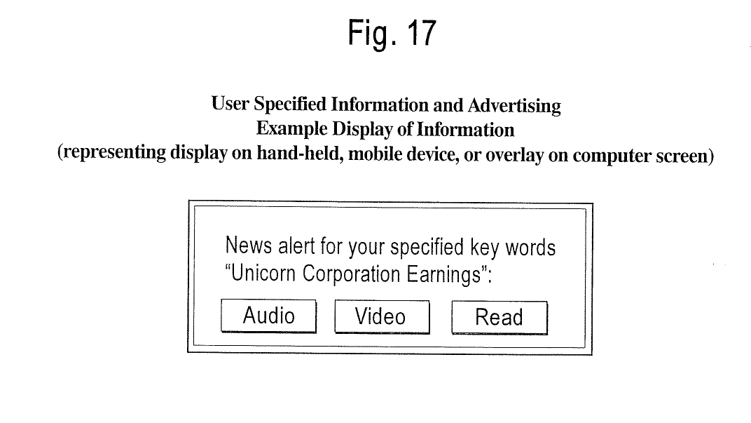

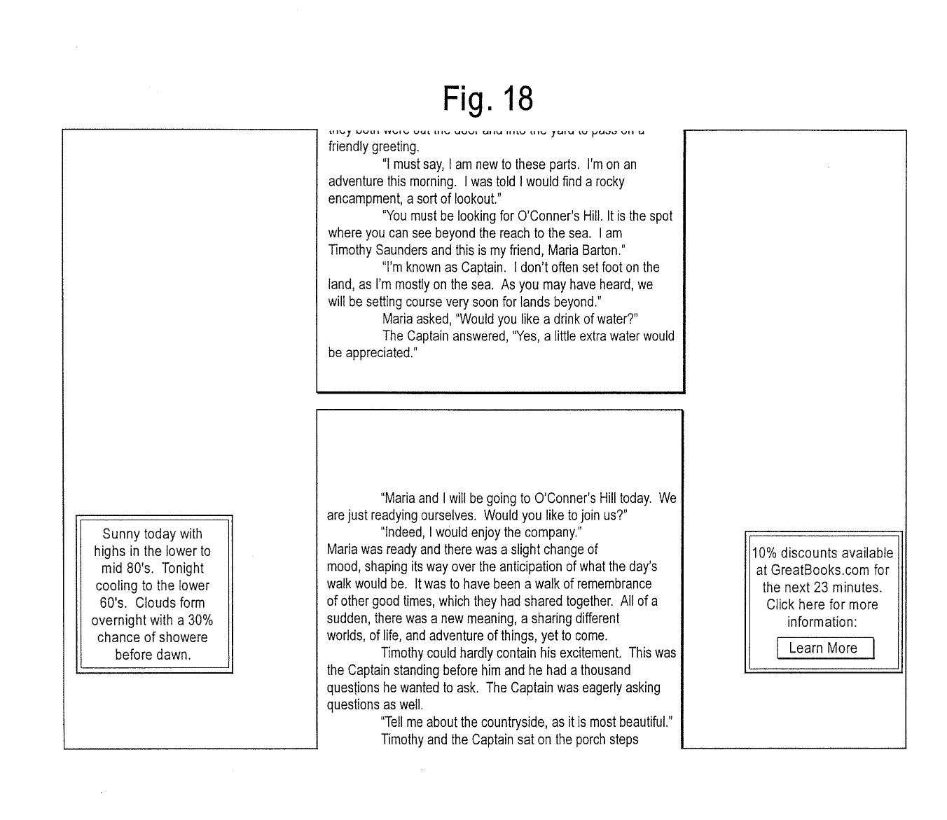

In FIG. 17, a news alert has been presented on a hand-held or wireless unit. FIG. 18 is a screen displaying an exemplary output from an information service combined with an output from a weather service and an advertisement.

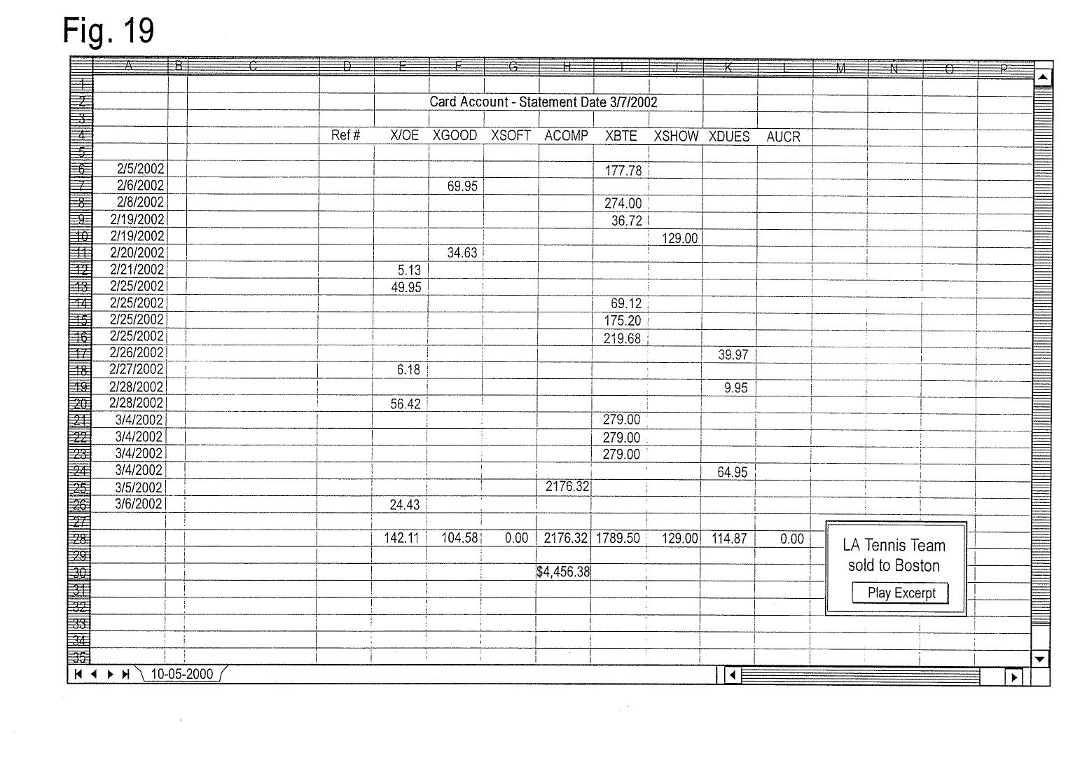

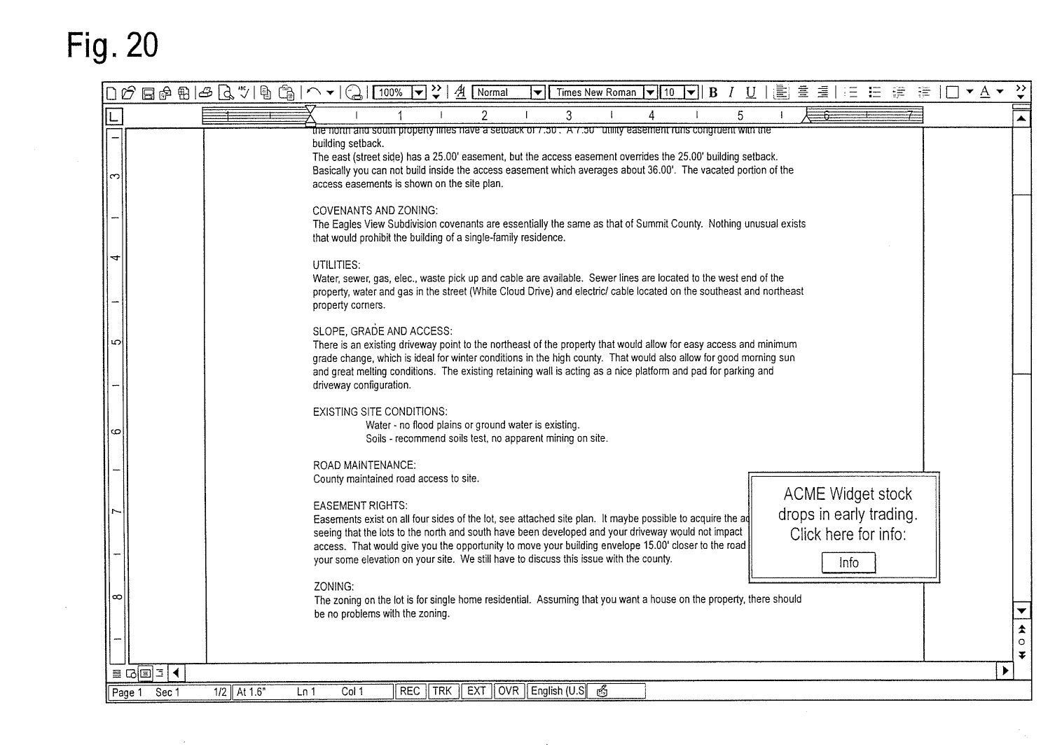

FIG. 19 is a screen displaying a spread sheet being executed with an excerpt concerning sports being presented. FIG. 20 is a screen displaying an information services excerpt in combination with other software running on the user station or presentation device.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1-38. (canceled)

39. A method for presenting excerpts of infonnation broadcasts comprising:
using at least some closed caption text to access at least some excerpts of the information broadcasts, wherein the broadcasts comprise at least one of news, weather, sports, traffic, financial or emergency broadcasts, and wherein an excerpt comprises at least one of a portion of a broadcast or an entire broadcast, and wherein at least some of the excerpts are transmitted via a communications link, to a user device for presentation.

40. A method as in claim 39 which includes presenting a list of at least some classifications of information broadcasts on a visual display and enabling a user to select at least some classifications of information broadcasts to be presented.

41. A method as in claim 40 wherein the classifications of information broadcasts offered on the visual display comprise at least in part at least one of the time or frequency of the presentation of the excerpts.

42. A method as in claim 40 wherein the classifications of information offered on the visual display may vary based on at least one of a user's location, gender, age, occupation, income, interests or other demographic data.

43. A method as in claim 40 which includes assessing a cost to a user wherein the cost varies based on the classifications selected.

44. A method as in claim 39 wherein at least some excerpts may be transmitted to the user device substantially immediately upon becoming available.

45. A method as in claim 39 which includes collecting information for at least in part for at least one of the popularity or the frequency of presentation of at least some of the presented items.

46. A method as in claim 39 which includes collecting information for at least in part for at least one of billing-related purposes, charging fees, managing fees paid, or managing subscription level.

47. A method as in claim 39 which includes collecting information for at least in part for at least one of royalty-type payments or payment for access to information broadcasts.

48. A method as in claim 39 which includes selecting at least some excerpts to be presented to a user by at least one of a key word phrase, words typed by a user or key entered text.

49. A method as in claim 39 which includes converting at least some words spoken in at least some excerpts to a digital representation and using same at least in part for the selection of excerpts to be presented.

50. A method as in claim 39 which includes at least one of converting a description of the subject matter at least in part of at least some excerpts to a digital representation or entering the description of at least a portion of the subject matter of at least some excerpts into a data entry screen, and using same at least in part for the selection of excerpts to be presented.

51. A method as in claim 39 which includes selecting a specific excerpt to be presented by selecting from a visual display, wherein the display at least in part lists at least one of at least some subject matter for at least some excerpts or at least some words spoken in at least some excerpts.

52-130. (canceled)
